(19) United States
(12) Patent Application Publication
(10) Pub. No.: US 2016/0039608 A1
(43) Pub. Date: Feb. 11, 2016

(54) Ceramic Chute Liner

(71) Applicant: Tega Industries Limited, Kolkata, West Bengal (IN)

(72) Inventor: Gour Chandra DAS, Kolkata, West Bengal (IN)

(21) Appl. No.: 14/781,779

(22) PCT Filed: Jul. 23, 2013
(86) PCT No.: PCT/IN2013/000459

§ 371 Date: Oct. 1, 2015

(30) Foreign Application Priority Data
Apr. 9, 2013 (IN) 396/KOL/2013

(51) Int. Cl. B65G 11/16

(52) U.S. Cl. CPC B65G 11/166

(57) ABSTRACT

A ceramic chute liner (10) comprising of a plurality of mechanically interlocked ceramic blocks (1). The corresponding mechanically interlocked ceramic blocks (1) have rubber films between them along respective adjoining surfaces such that, the ceramic blocks (1) are bonded with each other with substantial strength and the impact force is substantially reduced.

### FIELD OF THE INVENTION

The present invention relates in general to chute liners in bulk material handling, and in particular to a mechanically interlocked ceramic chute lining system where the ceramic blocks forming the liner are mechanically interlocked, the ceramic blocks are embedded on a rubber matrix for providing padding effect and include a base metal adapted for fixing the liner assembly with the chute wall by means of studs.

### BACKGROUND AND PRIOR ART

In material handling operations, conveyor belts are used for conveying or transporting material from one station to another station. When material has to be transferred between conveyors at different heights or between conveyors moving in different directions, chutes are used. Chutes are flat plates, having relatively smooth transferring surface, arranged at different angles to transfer or guide materials along the chute under force of gravity. Since the ore particles are dense and hard and discharged from the conveyor belt to the chute at considerable velocity, they may scratch and scrape away on the surface of the chute resulting in severe chute wear, if left unprotected. This wear may finally tear the plate, forming holes in chute faces, leading to leakage of material. Hence chutes have to be replaced, which activity stops the production for a long time. This downtime while the conveyer system is not in operation, results in loss of productivity. Such losses need to be kept at a minimum.

To avoid this, liners are used. Liners are small rectangular blocks, used as sacrificing cover for chutes. These are mechanically fastened to the chute.

### Benefits of Chute Lining

1) Facilitates repair and replacement of sliding surface
2) Means of correcting the performance of an inadequate chute
3) Avoids abrasion wear of chute
4) Reduces impact wear, noise, dust and material degradation
5) Promotes smooth flow
6) Avoids build-up of material
7) Prevents chemical reaction or corrosion of both chute and product

Chute liners are well known in the art. They can be of hard-wear type made of steel plates or ceramic tiles, or may be of low friction type made of UHMWPE (Ultra High Molecular Weight Polyethylene). The choice of the material of the liners depends upon the material handled by the system and site condition. The present invention concerns ceramic tile liners. They are dry pressed high alumina ceramic tiles and are normally manufactured in standard sizes. Ceramic liners have been used in the bulk solid handling industries to address the problem of high wear and abrasion.

An example of the above referred liners can be found in the U.S. Pat. No. 3,607,606 where ceramic bodies are embedded in a rubber material. The ceramic bodies have a high resistance to wear while the rubber material serves as shock absorber to reduce the risk of the brittle ceramic bodies cracking when hit by pieces of material.

In U.S. patent application Ser. No. 12/789,272 the composite liners generally comprise a base metal and one or more ceramic inserts embedded in the base metal. The composite liners exhibit improved resistance to wear and therefore have a longer usable life than the liners formed of the base metal alone.

An another example of the above referred liners can be found in Indian Patent no. 250582 wherein the wear-resistant liner has an outwardly directed surface with a certain thickness, over which material in the form of pieces of particles is intended to move. The wear-resistant liner comprises elastomeric material mainly adapted to absorb impact energy and wear-resistant members mainly adapted to resist wear.

However, during different application, the liner is subjected not only to abrasion wear but also to a certain degree of impact wear. Ceramic tiles when cemented directly on a steel surface have the advantage of resisting abrasion wear but cannot absorb impact energy. This has resulted in the development of liners having ceramic embedded in rubber matrix. It has been observed that in the conventional ceramic liners there is a tendency of ceramic blocks getting dislodged during operation. Once a single block gets dislodged, the surrounding area becomes prone for adjacent blocks to get dislodged. This leads ultimately to the failure of the liner. Worn or damaged liners may periodically be removed from a chute and replaced with new liners which is disadvantageous from a maintenance point of view as the existing conventional liners are fixed with the chute by bolting the liners with the chute wall, thus making the replacement process difficult, labour intensive and time consuming.

There has thus been a persistent need to design a suitable ceramic chute liner or chute lining arrangement to improve the life of the ceramic liner which eliminates the chance of dislodgement and further in case of dislodgement of a ceramic block, replacement is limited to that part only without hampering the whole liner arrangement. This makes the replacement process simple, requires less human intervention and also less time consuming. Hence the downtime of the plant is reduced.

The present invention meets the aforesaid long felt needs and other needs associated therewith.

### OBJECTS OF THE INVENTION

The principal object of the present invention is to provide a ceramic chute liner which is substantially durable and compact and which ensures that chances of dislodging between ceramic blocks during operation are substantially nullified.

Another object of the invention is to provide a ceramic chute liner which has enhanced service life at critical operating conditions which results in profitability.

Yet another object of the invention is to provide a ceramic chute liner which has Low coefficient of friction.

Another object of the present invention is to provide a ceramic chute liner which has a predictable wear pattern.

A further object of the invention is to provide a ceramic chute liner which reduces cost of annual maintenance and replacement.

A further object of the invention is to provide a ceramic chute liner which allows easy replacement and maintenance.

### SUMMARY OF INVENTION

Accordingly, the present invention provides a ceramic chute liner comprising of a plurality of mechanically interlocked ceramic blocks. The corresponding mechanically interlocked ceramic blocks have thin rubber film between them along respective adjoining surfaces. This ensures that the ceramic blocks are bonded with each other with substantial strength and the impact force is substantially reduced. Preferably, the vertical faces at the front and rear ends of each block are provided with a contour comprising of a protruded part and a depressed part and the vertical faces at the lateral ends of each block are plane surfaces. The blocks are adjoined along the vertical faces at the respective front and rear ends and also along the vertical faces at the respective lateral ends.

The protruded part of one block can securely receive the depressed part of another block for mechanical interlocking between the blocks.

More preferably, a first thin film of rubber is provided in between vertical faces at the front and rear ends of two adjoining blocks and a second thin film of rubber is provided between the vertical faces at the lateral ends of two adjoining ceramic blocks.

Most preferably, the first and second rubber films and the blocks are bonded with each other through chemical bonding and the blocks are embedded in a rubber matrix which comprises at least a metal plate for fixing the liner on to the chute wall through studs and the blocks of two adjacent rows are arranged to be asymmetric with each other.

### BRIEF DESCRIPTION OF THE ACCOMPANYING DRAWINGS

The nature and scope of the present invention will be better understood from the accompanying drawings, which are by way of illustration of some preferred embodiments which are exemplary and does not impose any limitation on the scope of the invention. In the accompanying drawings,

FIG. 1 is a top view of the ceramic liner assembly according to the present invention.

FIG. 2 is the isometric view of a single ceramic block unit.

FIG. 3a is a top view of a group of two such ceramic block units shown in FIG. 2.

FIG. 3b is a top view of a group of several such ceramic units shown in FIGS. 2 and 3a.

FIG. 3c is the isometric view of a single ceramic block unit according to another preferred embodiment.

FIG. 3d is a top view of the ceramic unit shown in FIG. 3c.

FIG. 3e is the top view of several such ceramic units shown in FIGS. 3c and 3d

FIG. 4a is the isometric view of a single ceramic block unit according to another preferred embodiment.

FIG. 4b is a top view of the ceramic unit shown in FIG. 4a.

FIG. 4c is the top view of several such ceramic units shown in FIGS. 4a and 4b.

FIG. 5 is a lateral view of the liner arrangement shown in FIG. 1.

### DETAILED DESCRIPTION OF THE INVENTION

The following describes exemplary preferred embodiments of the present invention, which are purely for the sake of understanding the performance of the invention, and do not impose any limitation on its scope.

All through the specification including the claims, the words “chute”, “hopper”, “conveyor”, “belt”, “liner”, “bulk material”, “abrasion”, “wear”, “impact load”, “rubber pad” and “ceramic blocks”, “protrusions”, “depressions”, “grooves”, “notches or tips” are to be interpreted in the broadest sense of the respective terms, and include all similar items in the field known by other terms, as may be clear to persons skilled in art. Restriction or limitation if any referred to in the specification, is solely by way of example and understanding the present invention.

The present invention provides composite liners made up of interlocked ceramic blocks characterized in having thin rubber film between them and the blocks being embedded on a rubber matrix. Such a lining arrangement results in improved resistance to wear and therefore, have a longer usable life than conventional liners. The proposed liner system provides easy replacement of any damaged part in case of wear and thereby reduces the downtime of a plant.

The composite ceramic liner of the present invention comprises of a plurality of ceramic blocks that are mechanically interlocked. Each individual ceramic block is bonded with rubber both on its vertical as well as horizontal surfaces, thereby eliminating any chance of dislodging the ceramic blocks in use. Further, since the ceramic blocks are embedded on a rubber covering, they help withstand impact loads. These liners are provided with steel back plates to facilitate fixing them on the chute wall with the help of studs.

The basic constructional feature of the ceramic chute liner as described in the preceding paragraphs and the advantages derived out of it will now be further explained in the following description with reference to the accompanying drawings.

In the drawings, like reference numerals represent like features and the expressions “front”, “rear”, “top”, “lateral”, “isometric”, and like expressions should be construed with reference to the orientation of the chute liner during use.

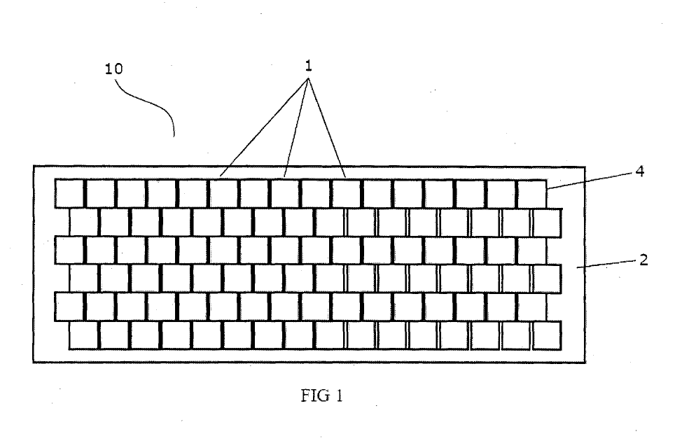

FIG. 1 represents a ceramic chute liner arrangement (10) comprising of a plurality of mechanically interlocked ceramic blocks (1) with thin rubber film between them. The ceramic blocks (1) are embedded in a rubber matrix (2). The two adjacent rows of ceramic blocks (1) are arranged in asymmetric way, thus further reducing the risk of dislodgement of the ceramic blocks in the vertical direction.

FIG. 5, which is a lateral view of the arrangement shown in FIG. 1 shows that the rubber matrix (2) also has a back plate (9) embedded on its back face, which is adapted for fixing the whole liner arrangement with the chute wall (not shown) by means of studs (not shown). It would be clear from FIGS. 1 and 5, that the liner assembly (10) is embedded in the rubber matrix (2), to absorb the impact energy during bulk material handling.

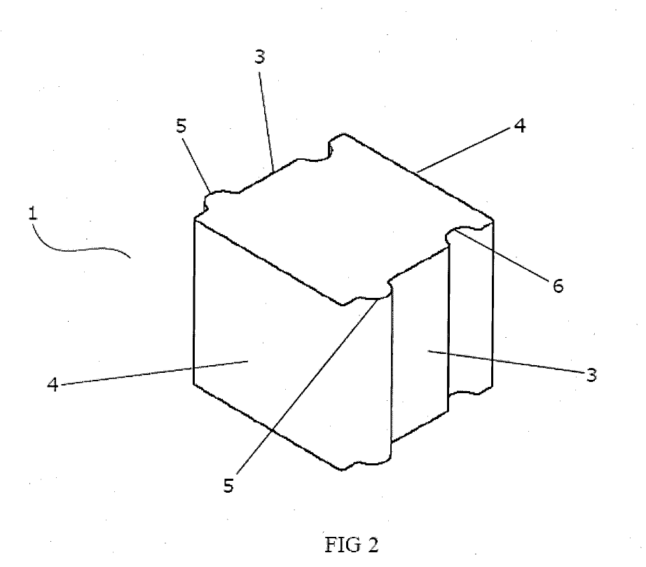

FIG. 2 is a detailed view of a ceramic block unit (1). The vertical faces (3) at the front and rear end of each block (1) have a circular protruded part (5) and a corresponding circular depressed part (6). The gap between the protruded (5) and depressed parts (6) at the front end and the rear end is definite and predetermined for each block. The FIG. 2 also shows the vertical faces (4) at the lateral ends of the block (1). These are plane surfaces. It can be seen from FIG. 2 also that each block (1) has a top surface and a bottom surface.

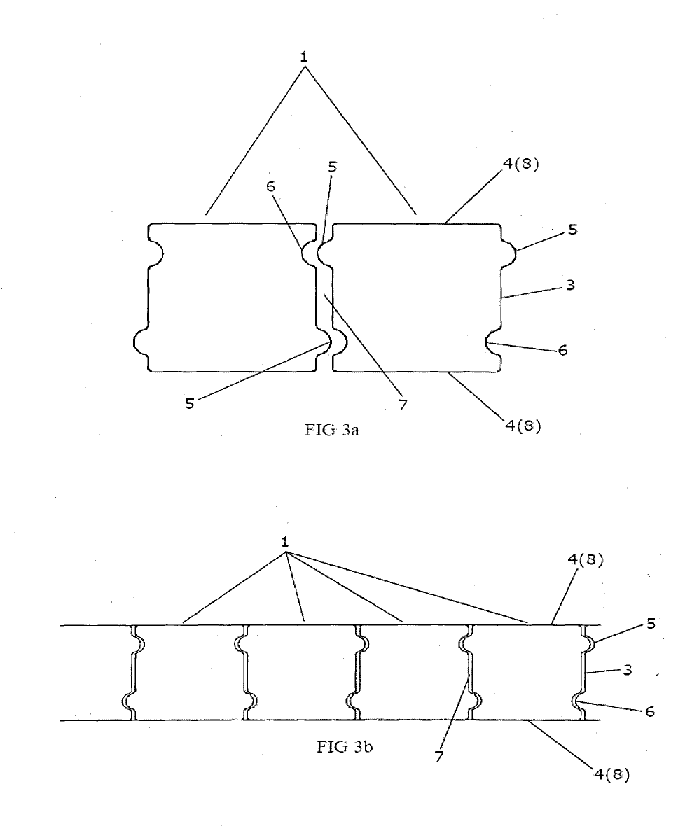

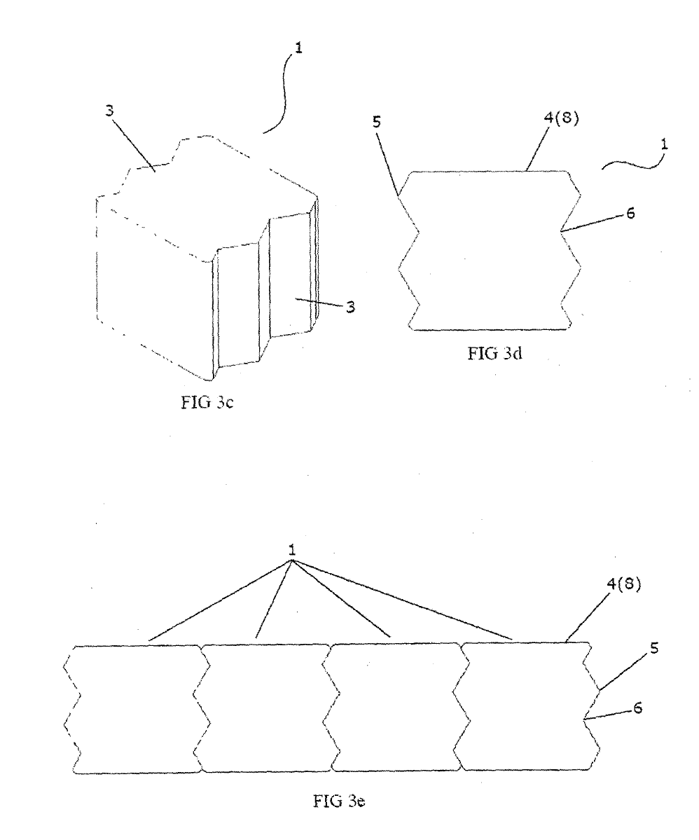

FIG. 3a is a view of two such ceramic blocks (1), one of which is shown in FIG. 2. It would be clear from this figure that two adjacent ceramic blocks are placed side by side in opposite direction to ensure that the protruded part (5) of one block can receive the depressed part (6) of another block in order to achieve mechanical interlocking between the blocks.

The protruded part (5) of a first ceramic block is complimentary to in shape and adapted to be mechanically interlocked with the depressed part (6) of the second block and the depressed part (6) of first ceramic block is also complimentary to in shape and adapted to be mechanically interlocked with the protruded part (5) of the second block. This interlocking mechanism between any two adjacent blocks ensures tight fitting of the blocks.

It would be also clear from the FIGS. 2 and 3a that the vertical surfaces (4) at the lateral ends of each block are plane surfaces devoid of any protruded or depressed parts.

Referring to FIG. 3a, a first thin film of rubber (7) is provided in between two adjoining ceramic blocks (1) at the front and rear vertical faces (3) of each block (1). A second thin film of rubber (8) is provided in between the vertical surfaces (4) at the lateral ends in between two adjoining ceramic blocks (1). The ceramic blocks (1) are adjoined at vertical faces (3) along their front and rear ends and also at the vertical faces (4) along their lateral ends. Preferably, though not essentially, the rubber films (7, 8) and the ceramic units (1) can be bonded with each other through chemical bonding, thus eliminating the risk of dislodgement of the individual blocks.

FIG. 3b is a top view of an arrangement of a plurality of ceramic blocks (1). The interlocking aspect as explained with reference to FIGS. 2 and 3a would be further clear from this figure. It shows how a plurality of such ceramic blocks (1) is actually arranged. However, it shows ceramic blocks (1) adjoined only along the front and rear vertical faces(3). It should be understood that ceramic blocks (1) are also adjoined along the vertical faces (4) along the lateral ends of each block (1) and this is within the scope of the present invention. FIG. 3c, FIG. 3d and FIG. 3e are views of another embodiment of the wear-resistant ceramic liners, according to the invention.

FIG. 3c is a view of a ceramic block (1) provided with a contour having triangular grooves (6) and notches (5) on the vertical faces (3) at the front and rear ends of the ceramic block (1). The grooves (6) constitute the depressed part while the notches or tips (5) constitute the protruded part. This contour pattern would be further clear from the top view in FIG. 3d. The rest of the features are all identical with the previous embodiments illustrated in FIGS. 2, 3a and 3b and are not reiterated for the sake of brevity.

From the arrangement shown in FIG. 3e it would be clear that a plurality of ceramic blocks (1), each of which are shown in FIG. 3c are arranged side-by-side where the triangular tip or notch (5) of a first block is inserted in the groove face (6) of the second adjacent block to facilitate the mechanical interlocking between the blocks. It should be understood that ceramic blocks (1) are also adjoined along the vertical faces (4) along the lateral ends of each block (1) and this is within the scope of the present invention.

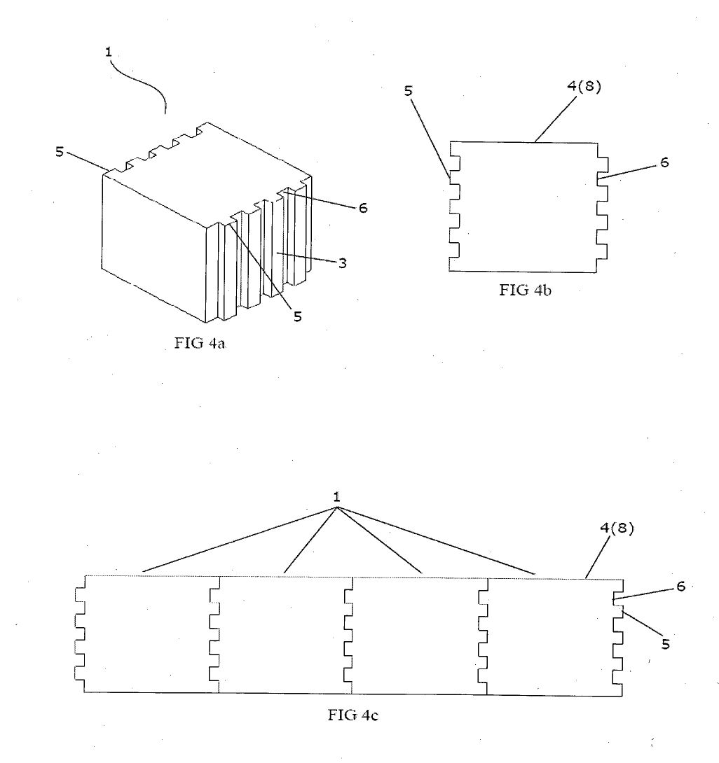

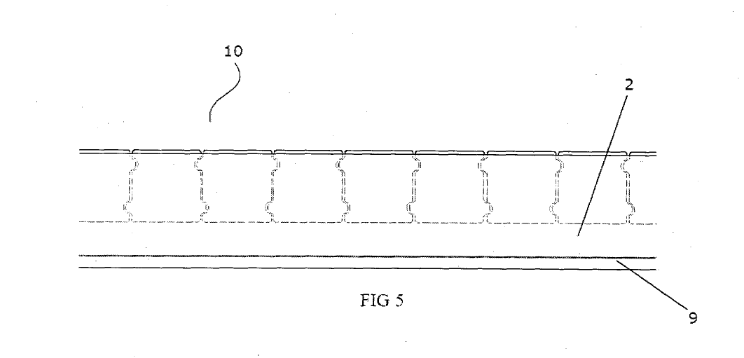

As in the earlier embodiments illustrated in FIGS. 1, 3a and 3b, vertical faces (4) at the lateral ends of each block are plane surfaces. Similarly, a first thin film of rubber (not shown in detail in FIG. 3e) is provided in between two adjoining ceramic blocks (1) at the front and rear vertical faces (3) of each block (1) and a second thin film of rubber (8) is provided in between the vertical surfaces (4) at the lateral ends in between two adjoining ceramic blocks (1). The ceramic blocks (1) are adjoined at vertical faces (3) along their front and rear ends and also at the vertical faces (4) along their lateral ends. FIGS. 4a, 4b and 4c are views of another preferred embodiment. These views correspond to the views in FIGS. 3c, 3d and 3e respectively and function exactly in the same manner and have same features. These are not reiterated again for the sake of brevity. Only difference is that the vertical faces (3) at the rear and front ends of each block (1) have rectangular grooves (6) as depressed parts and rectangular notches or tips (5) as the corresponding protruded part, which fit into each other, exactly in the same manner as described in the previous embodiments.

The rubber layers (7,8) provided between ceramic units (1) along their adjoining surfaces (3,4) throughout the body of the liner, provide the desired cushioning effect to reduce the impact force which damages the ceramic blocks. This also ensures that the ceramic blocks (1) do not get dislodged easily during operation. The rubber layer (7,8)-ceramic surface (3,4) bonding and also the protrusion (5), depression (6) arrangement at the front and rear vertical surfaces (3) ensure this aspect in particular, while especially, the presence of rubber layer (7,8) provide the desired cushioning effect to reduce the impact force. The wear-resistant ceramic block shapes described above are only examples of conceivable shapes. A person skilled in the art understands that other shapes are possible and all such shapes are within the scope of the present invention. The shapes shown are not consequential to the present invention.

As stated before, FIG. 5 is a view of arrangement shown in FIG. 1 which essentially shows the back portion of the rubber matrix (2) of the composite liner (10). The rubber matrix has a metal back plate (9) embedded on to it. This metal back plate (9) is adapted to fixing the liner (10) on to the chute wall through studs (not shown). This in particular ensures that if any ceramic block (1) needs to be replaced, this can be done easily without causing prolonged hindrance to the operation.

The metal back plate can be made of steel. However, other materials such as iron, alloys of iron, aluminum and so on may be used and all such material fall within the scope of the present invention.

It would be clear from FIGS. 1 and 5, that the liner assembly (10) comprising of mechanically interlocked blocks, is embedded in the rubber matrix (2), to absorb the impact energy during bulk material handling. Preferably, the mechanically interlocked blocks (1) are fixed to the rubber matrix (2) by adhesives. The rubber matrix (2) covers the bottom as well as the top surfaces of the composite liner. This configuration helps to withstand impact load by providing padding effect.

The non limiting advantages of the present invention are:
1. They are substantially durable and compact and chances of dislodging of ceramic blocks during operation are substantially nullified.
2. Enhanced service life at critical operating conditions results in profitability.
3. Low coefficient of friction.
4. Predictable wear pattern.
5. Reduces cost of annual maintenance and replacement.
6. Reduces shut down frequency, hence increases productivity.
7. No ceramic dislodges during operation.

The present invention has been described with reference to some non-limiting preferred embodiments and drawings for the sake of understanding and it includes all legitimate developments within the ambit of what has been described hereinbefore and claimed hereinafter.

1. A ceramic chute liner (10) comprising of a plurality of mechanically interlocked ceramic blocks (1), the corresponding mechanically interlocked ceramic blocks (1) having rubber films (7,8) between them along respective adjoining surfaces (3,4) such that, the ceramic blocks (1) are bonded with each other with substantial strength and the impact force is substantially reduced.

2. The chute liner (10) as claimed in claim 1, wherein the vertical faces (3) at the front and rear ends of each block (1) are provided with a contour comprising of a protruded part (5) and a depressed part (6) and the vertical faces (4) at the lateral ends of each block (1) are plane surfaces and blocks (1) are adjoined along the vertical faces (3) at the respective front and rear ends and also along the vertical faces (4) at the respective lateral ends.

3. The chute liner (10) as claimed in claim 2, wherein the protruded part (5) of one block (1) can securely receive the depressed part (6) of another block (1) for mechanical interlocking between the blocks.

4. The chute liner (10) as claimed in claim 2, wherein the gap between said protruded (5) and depressed (6) parts is definite and predetermined for each block.

5. The chute liner (10) as claimed in claim 2, wherein a first thin film of rubber (7) is provided in between vertical faces (3) at the front and rear ends of two adjoining blocks (1) and a second thin film of rubber (8) is provided between the vertical faces (4) at the lateral ends of two adjoining ceramic blocks (1).

6. The chute liner (10) as claimed in claims 2 and 3, wherein the protruded (5) and depressed (6) parts are triangular or circular notches (5) and corresponding triangular or circular grooves (6) respectively.

7. The chute liner (10) as claimed in claims 2 and 3, wherein the protruded (5) and depressed (6) parts are rectangular notches (5) and corresponding rectangular grooves (6) respectively.

8. The chute liner (10) as claimed in claims 1 and 5, wherein the first and second rubber films (7, 8) and the blocks (1) are bonded with each other through chemical bonding.

9. The chute liner (10) as claimed in claim 1 wherein the blocks (1) are embedded in a rubber matrix (2) which comprises at least a metal plate (9) for fixing the liner (10) on to the chute wall through studs and the blocks (1) of two adjacent rows are arranged to be asymmetric with each other.

10. The chute liner (10) as claimed in claim 9, wherein the metal back plate (9) is made of iron or steel or other alloys of iron or aluminium.
